(19) United States
(12) Patent Application Publication
(10) Pub. No.: US 2010/0223419 A1
(43) Pub. Date: Sep. 2, 2010

(54) COPY CIRCUMVENTION IN A VIRTUAL NETWORK ENVIRONMENT

(75) Inventors: Omar Cardona, Cedar Park, TX (US); James Brian Cunningham, Austin, TX (US); Baltazar DeLeon, III, Austin, TX (US); Matthew Ryan Ochs, Austin, TX (US)

Correspondence Address: DILLON & YUDELL LLP, 8911 N. CAPITAL OF TEXAS HWY.,, SUITE 2110, AUSTIN, TX, 78759, US

(73) Assignee: International Business Machines Corporation, Armonk, NY (US)

(21) Appl. No.: 12/396,257

(22) Filed: Mar. 2, 2009

(51) Int. Cl. G06F 12/16; G06F 12/00

(52) U.S. Cl. 711/6; 711/162; 718/1; 711/E12.001; 711/E12.103

(57) ABSTRACT

A method, system, and computer program product for circumventing data copy operations in a virtual network environment. The method includes copying a data packet from a user space to a first kernel space of a first logical partition (LPAR). Using a hypervisor, a mapped address of a receiving virtual Ethernet driver in a second LPAR is requested. The first mapped address is associated with a buffer of the receiving virtual Ethernet driver. The data packet is copied directly from the first kernel space of the first LPAR to a destination in a second kernel space of the second LPAR. The destination is determined utilizing the mapped address. The direct copying to the destination bypasses (i) a data packet copy operation from the first kernel space to a transmitting virtual Ethernet driver of the first LPAR, and (ii) a data packet copy operation via the hypervisor. The receiving virtual Ethernet driver is notified that the data packet has been successfully copied to the destination in the second LPAR.

### BACKGROUND OF THE INVENTION

The present disclosure relates to an improved data processing system. In particular, the present disclosure relates to a logically partitioned data processing system. More specifically, the present disclosure relates to circumventing copying/mapping in a virtual network environment.

In advanced virtualized systems, Operating System (OS) instances have the ability to intercommunicate via a virtual Ethernet (VE). In a logically partitioned data processing system, a logical partition (LPAR) communicates with external networks via a special partition known as a Virtual Input/Output Server (VIOS). The VIOS provides I/O services, including network, disk, tape, and other access to partitions without requiring each partition to own a physical I/O device.

Within the VIOS, a network access component known as a shared Ethernet adapter (SEA), or bridging adapter, is used to bridge between a physical Ethernet adapter and one or more virtual Ethernet adapters. A SEA includes both a physical interface portion and a virtual interface portion. When a virtual client desires to communicate to an external client, data packets are transmitted to and received by the virtual portion of the SEA. The SEA then re-transmits the data packet from the physical portion of the SEA to the external client. This solution follows a traditional networking approach in keeping each adapter (virtual and/or physical) and the adapter's associated resources independent of each other.

### SUMMARY OF THE ILLUSTRATIVE EMBODIMENTS

A method, system, and computer program product for circumventing data copy operations in a virtual network environment using a shared Ethernet adapter are disclosed. The method includes copying a data packet from a user space to a first kernel space of a first logical partition (LPAR). Using a hypervisor, a mapped address of a receiving virtual Ethernet driver in a second LPAR is requested. The first mapped address is associated with a buffer of the receiving virtual Ethernet driver. The data packet is copied directly from the first kernel space of the first LPAR to a destination in a second kernel space of the second LPAR. The destination is determined utilizing the mapped address. The direct copying to the destination bypasses (i) a data packet copy operation from the first kernel space to a transmitting virtual Ethernet driver of the first LPAR, and (ii) a data packet copy operation via the hypervisor. The receiving virtual Ethernet driver is notified that the data packet has been successfully copied to the destination in the second LPAR.

The above as well as additional features of the present invention will become apparent in the following detailed written description.

### BRIEF DESCRIPTION OF THE SEVERAL VIEWS OF THE DRAWINGS

Aspects of the invention itself will best be understood by reference to the following detailed description of an illustrative embodiment when read in conjunction with the accompanying drawings, where:

FIG. 1 illustrates a block diagram of an exemplary data processing system in which the present invention may be implemented;

FIG. 2 illustrates a block diagram of a processing unit in a virtual Ethernet environment, according to an embodiment of the present invention;

FIG. 3 illustrates a block diagram of a processing unit having an internal virtual client transmitting to an external physical client, according to an embodiment of the present invention;

FIG. 4 depicts a high-level flowchart for circumventing data copy operations in a virtual network environment, according to an embodiment of the present invention; and

FIG. 5 depicts a high-level flowchart for circumventing data copy operations in a virtual network environment using a shared Ethernet adapter, according to another embodiment of the present invention.

### DETAILED DESCRIPTION OF THE INVENTION

When segregating each Ethernet adapter (virtual and/or physical) and the Ethernet adapter's associated resources, a considerable number of copies are required to perform the transmission and reception of data packets between (i) virtual Ethernet adapters in a virtualized environment via a hypervisor, and (ii) virtual Ethernet adapters and physical Ethernet adapters via the hypervisor and SEA. As a result, transmission at a 10 Gigabit Ethernet (10 GbE or 10 GigE) line rate standard with a 1500 byte maximum transmission unit (MTU) is difficult to achieve under such a virtual network environment using a SEA. In addition, OS and/or device indirection coupled with increased data packet processing leads to greater CPU usage and overall latency per data packet. The present invention avoids the above effects by effectively circumventing various copy operations.

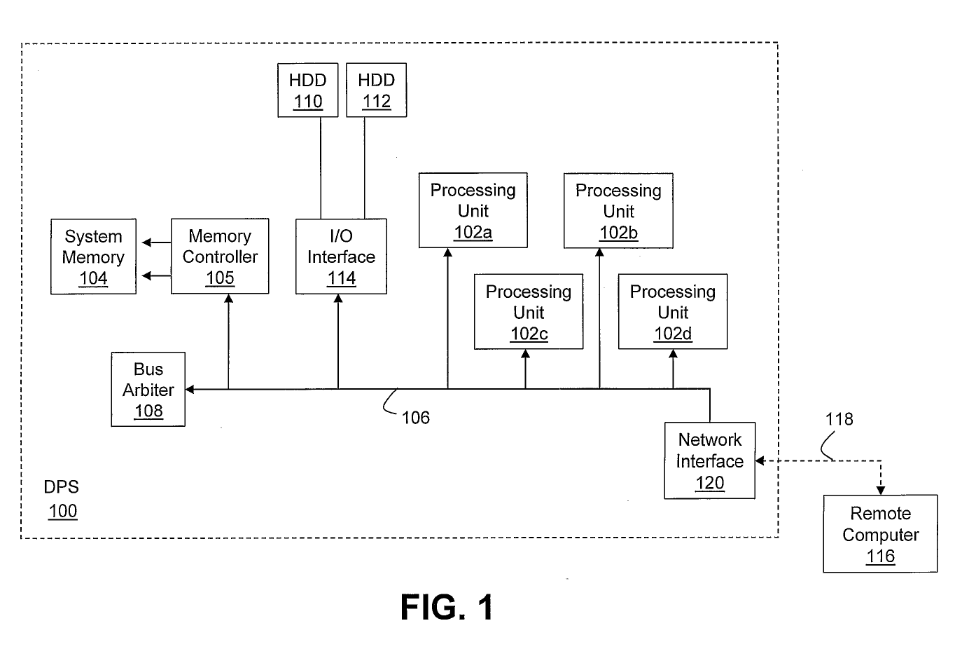

With reference now to the figures, and in particular to FIG. 1, there is depicted a block diagram of a data processing system (DPS) 100, with which the present invention may be utilized. For discussion purposes, the data processing system is described as having features common to a server computer. However, as used herein, the term “data processing system,” is intended to include any type of computing device or machine that is capable of receiving, storing and running a software product, including not only computer systems, but also devices such as communication devices (e.g., routers, switches, pagers, telephones, electronic books, electronic magazines and newspapers, etc.) and personal and home consumer devices (e.g., handheld computers, Web-enabled televisions, home automation systems, multimedia viewing systems, etc.).

FIG. 1 and the following discussion are intended to provide a brief, general description of an exemplary data processing system adapted to implement the present invention. While parts of the invention will be described in the general context of instructions residing on hardware within a server computer, those skilled in the art will recognize that the invention also may be implemented in a combination of program modules running in an operating system. Generally, program modules include routines, programs, components, and data structures, which perform particular tasks or implement particular abstract data types. The invention may also be practiced in distributed computing environments where tasks are performed by remote processing devices that are linked through a communications network. In a distributed computing environment, program modules may be located in both local and remote memory storage devices.

DPS 100 includes one or more processing units 102a-102d, a system memory 104 coupled to a memory controller 105, and a system interconnect fabric 106 that couples memory controller 105 to processing unit(s) 102 and other components of DPS 100. Commands on system interconnect fabric 106 are communicated to various system components under the control of bus arbiter 108.

DPS 100 further includes storage media, such as a first hard disk drive (HDD) 110 and a second HDD 112. First HDD 110 and second HDD 112 are communicatively coupled to system interconnect fabric 106 by an input-output (I/O) interface 114. First HDD 110 and second HDD 112 provide nonvolatile storage for DPS 100. Although the description of computer-readable media above refers to a hard disk, it should be appreciated by those skilled in the art that other types of media which are readable by a computer, such as removable magnetic disks, CD-ROM disks, magnetic cassettes, flash memory cards, digital video disks, Bernoulli cartridges, and other later-developed hardware, may also be used in the exemplary computer operating environment.

DPS 100 may operate in a networked environment using logical connections to one or more remote computers, such as remote computer 116. Remote computer 116 may be a server, a router, a peer device, or other common network mode, and typically includes many or all of the elements described relative to DPS 100. In a networked environment, program modules employed by DPS 100, or portions thereof, may be stored in a remote memory storage device, such as remote computer 116. The logical connections depicted in FIG. 1 include connections over a local area network (LAN) 118, but, in alternative embodiments, may include a wide area network (WAN).

When used in a LAN networking environment, DPS 100 is connected to LAN 118 through an input/output interface, such as a network interface 120. It will be appreciated that the network connections shown are exemplary and other means of establishing a communications link between the computers may be used.

The depicted example is not meant to imply architectural or other limitations with respect to the presently described embodiments and/or the general invention. The data processing system depicted in FIG. 1 may be, for example, an IBM eServer pSeries system, a product of International Business Machines Corporation in Armonk, N.Y., running the Advanced Interactive Executive (AIX) operating system or LINUX operating system.

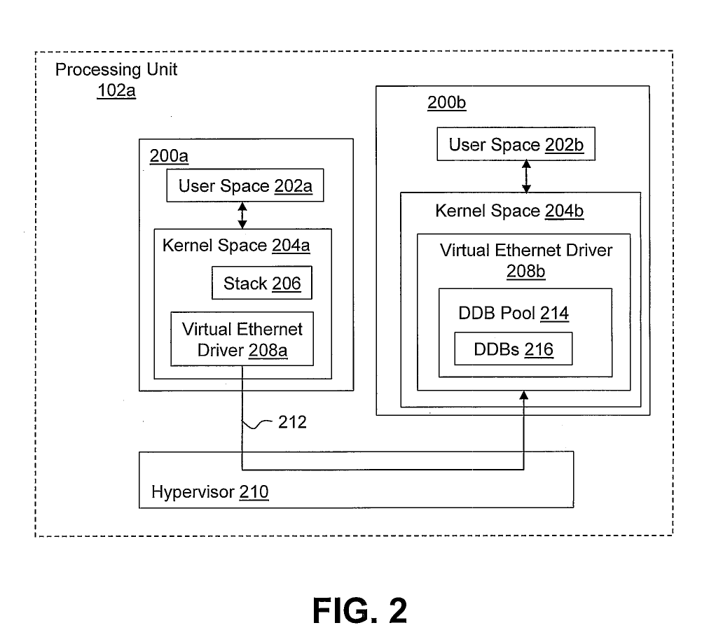

Turning now to FIG. 2, virtual networking components in a logically partitioned (LPAR) processing unit in accordance with an embodiment of the present disclosure are depicted. In this regard, a virtual Ethernet (VE) enables communications among virtual operating system (OS) instances (or LPARs) contained within the same physical system. Each LPAR 200 and its associated set of resources can be operated independently, as an independent computing process with its own OS instance residing in kernel space 204 and applications residing in user space 202. The number of LPARs that can be created depends on the processor model of DPS 100 and available resources. Typically, LPARs are used for different purposes such as database operation or client/server operation or to separate test and production environments. Each LPAR can communicate with other LPARs as if each other LPAR is in a separate machine through a virtual LAN 212.

In the depicted example, processing unit 102a runs two logical partitions (LPARs) 200a and 200b. LPARs 200a and 200b respectively include user space 202a and user space 202b. User space 202a and user space 202b are communicatively linked to kernel space 204a and kernel space 204b, respectively. According to one embodiment, user space 202a copies data to stack 206 in kernel space 204a. In order to transfer the data stored in stack 206 to its intended recipient in LPAR 200b, the data is mapped or copied to a bus (or mapped) address of a buffer of LPAR 200b.

Within LPARs 200a and 200b, virtual Ethernet drivers 208a and 208b direct the transfer of data between LPARs 200a and 200b. Each virtual Ethernet driver 208a and 208b has its own transmit data buffer and receive data buffer for transmitting and/or receiving data packets between virtual Ethernet drivers 208a and 208b. When a data packet is to be transferred from LPAR 200a to LPAR 200b, virtual Ethernet driver 208a makes a call to hypervisor 210. Hypervisor 210 is configured for managing the various resources within a virtualized Ethernet environment. Both creation of LPARs 200a and 200b and allocation of resources on processor 102a and data processing system 100 to LPARs 200a and 200b are controlled by hypervisor 210.

Virtual LAN 212 is an example of virtual Ethernet (VE) technology, which enables IP-based communication between LPARs on the same system. Virtual LAN (VLAN) technology is described by the IEEE 802.1Q standard, incorporated herein by reference. VLAN technology logically segments a physical network, such that layer 2 connectivity is restricted to members that belong to the same VLAN. This separation is achieved by tagging Ethernet data packets with VLAN membership information and then restricting delivery to members of a given VLAN.

VLAN membership information, contained in a VLAN tag, is referred to as VLAN ID (VID). Devices are configured as being members of a VLAN that is designated by the VID for that device. Such devices include virtual Ethernet drivers 208a and 208b. For example, virtual Ethernet driver 208a is identified to other members of VLAN 212, such as virtual Ethernet driver 208b, by means of a Device VID.

According to an embodiment of the invention, virtual Ethernet driver 208b stores a pool 214 of direct data buffers (DDBs) 216. DDB 216 is a buffer which points to an address of a receiving VE data buffer (i.e., an intended recipient of a data packet). DDB 216 is provided to stack 206 via a call to hypervisor 210 by VE driver 208a. Stack 206 performs a copy operation directly from kernel space 204a into DDB 216. This operation circumvents two separate copy/mapping operations: (1) a copy/map from kernel space 204a to virtual Ethernet driver 208a, and (2) a subsequent copy operation of a data packet by hypervisor 210 from the transmitting VE driver 208a to the receiving VE driver 208b. With regard to (2), no copy operation is required by hypervisor 210 since the packet data has been previously copied by stack 206 into a pre-mapped data buffer having an address pointed to by DDB 216. Thus, when VE driver 208a obtains a mapped, receive data buffer address at receiving VE driver 208b through hypervisor 210 and VE driver 208a copies directly into the mapped, receive data buffer in LPAR 200b, VE driver 208a will have effectively written into the memory location in receiving VE driver 208b that is referenced by DDB 216.

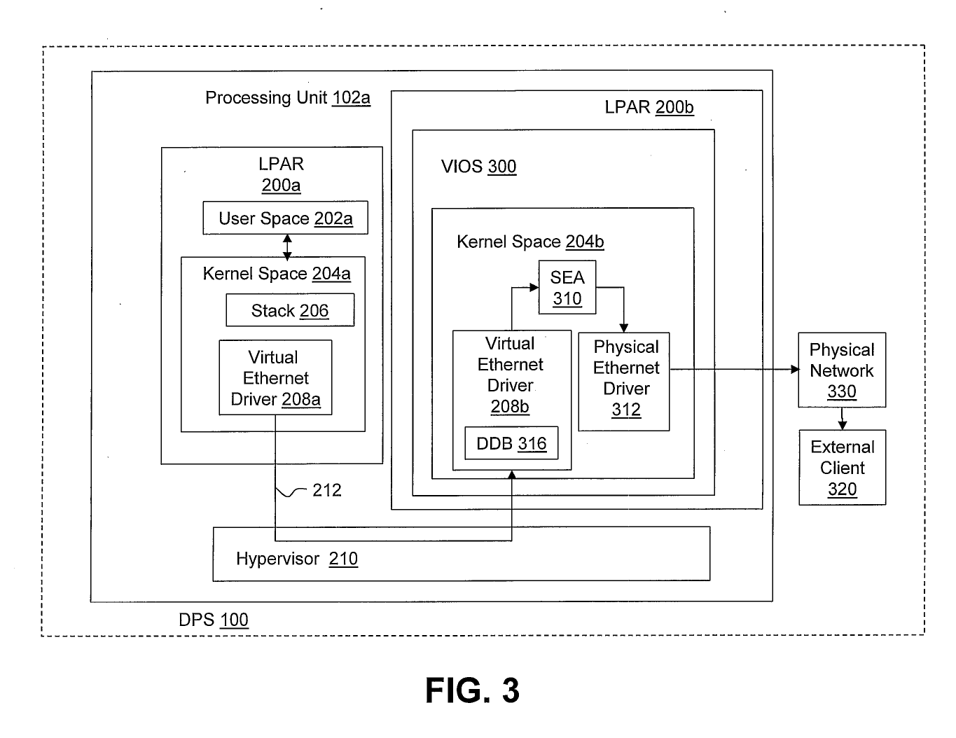

With reference now to FIG. 3, a physical Ethernet adapter shared by multiple LPARs of a logically partitioned processing unit is depicted, in accordance with an embodiment of the present disclosure. DPS 100 includes processing unit 102a, which is logically partitioned into LPARs 200a and 200b. LPAR 200b also runs virtual I/O server (VIOS) 300, which provides an encapsulated device partition that provides network, disk, and other access to LPARs 200a and 200b without requiring each partition to own a network adapter. The network access component of VIOS 300 is shared Ethernet adapter (SEA) 310. While the present invention is explained with reference to SEA 310, the present invention applies equally to any peripheral adapter or other device, such as I/O interface 114.

SEA 310 serves as a bridge between a physical network adapter interface 120 or an aggregation of physical adapters and one or more of VLANs 212 on VIOS 300. SEA 310 is configured to enable LPARs 200a and 200b on VLAN 212 to share access to an external client 320 via physical network 330. SEA 310 provides this access by connecting, through hypervisor 210, VLAN 212 with a physical LAN in physical network 330, allowing machines and partitions connected to these LANs to operate seamlessly as members of the same VLAN. SEA 310 enables LPARs 200a and 200b on processing unit 102a of DPS 100 to share an IP subnet with external client 320.

SEA 310 includes a virtual and a physical adapter pair. On the virtual side of SEA 310, VE driver 208b communicates with hypervisor 210. VE driver 208b stores a pool 314 of DDBs 316. DDB 316 is a buffer which points to an address of transmit data buffer (i.e., the intended location of the data packet) of physical Ethernet driver 312. On the physical side of SEA 310, physical Ethernet driver 312 interfaces with physical network 330. However, since a virtual client must interface with VIOS 300 before LPAR 200a can leave its virtualized environment to communicate with a physical environment, the physical transmit data buffer of physical Ethernet driver 312 is mapped as a receive data buffer at receiving VE driver 208b. Thus, when receiving VE driver 208b receives from VE driver 208a a data packet that is pre-mapped to the physical transmit data buffer of physical Ethernet driver 312, receiving VE driver 208b will have effectively written into the memory location in physical Ethernet driver 312 that is referenced by DDB 316. VIOS 300 forwards the data packet at receiving VE driver 208b to another driver which manages physical Ethernet driver 312.

The operation circumvents three separate copy/mapping operations: (1) a copy/map from kernel space 204a to virtual Ethernet driver 208a, (2) a subsequent copy operation of a data buffer by hypervisor 210 from the transmitting VE driver 208a to the receiving VE driver 208b via hypervisor 210, and (3) a subsequent copy operation of a data buffer from receiving VE driver 208b to physical Ethernet driver 312 via SEA 310.

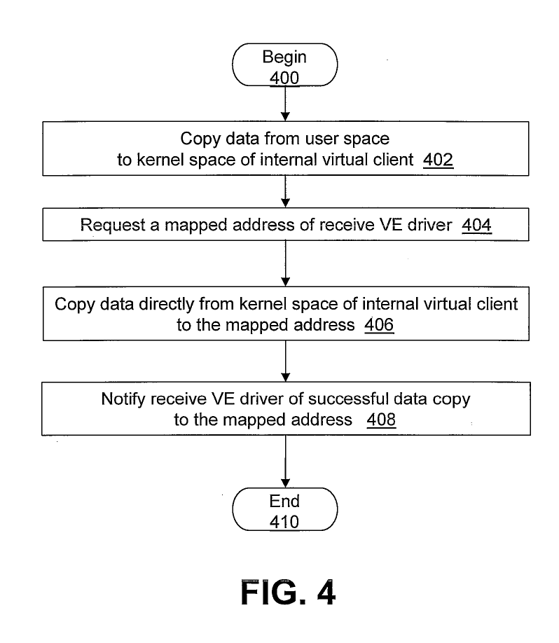

With reference now to FIG. 4, a flowchart of an exemplary process for circumventing data copy operations in a virtual network environment is depicted in accordance with an illustrative embodiment of the present invention. In this regard, reference is made to the elements described in FIG. 2. The process begins at initial block 401 and continues to block 402 which depicts a data packet being copied from user space 202a to kernel space 204a of an internal virtual client (i.e., LPAR 200a). Next, virtual Ethernet (VE) driver 208a requests an address of a mapped, receive data buffer of VE driver 208b, as depicted in block 404. This step is performed by a call by VE driver 208a to hypervisor 210 in response to a data packet transmit request by VE driver 208a. Hypervisor 210 acquires a direct data buffer (DDB) 216 from VE driver 208b. DDB 216 includes the address of a buffer in LPAR 200b to which the data packet is intended to be transmitted. Hypervisor 210 communicates the intended receive data buffer address to VE driver 208a and the receive data buffer address is handed up to stack 206 in kernel space 204a. Once the receive data buffer location is communicated to VE driver 208a, the process continues to block 406, which illustrates VE driver 208a in kernel space 204a copying the data packet directly from stack 206 to the mapped address of the receive data buffer of receiving VE driver 208b. Next, VE driver 208a performs a call to hypervisor 210 to notify receiving VE driver 208b that a data copy to the mapped, receive data buffer was successful (block 408). The process then terminates thereafter at block 410.

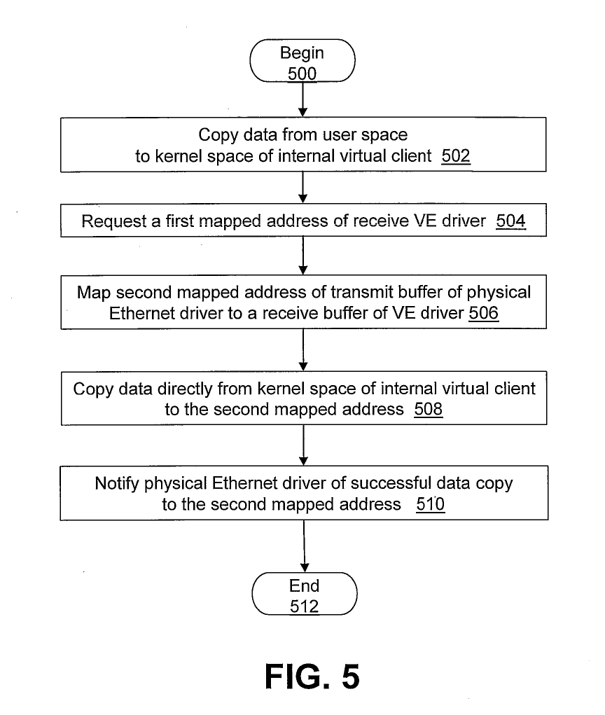

With reference now to FIG. 5, a flowchart of an exemplary process for circumventing data copy operations in a virtual network environment using a shared Ethernet adapter (SEA) is depicted in accordance with an illustrative embodiment of the present invention. In this regard, reference is made to the elements described in FIG. 3. The process begins at initial block 501 and continues to block 502, which depicts a data packet being copied from user space 202a to kernel space 204a of an internal virtual client (i.e., LPAR 200a). Next, virtual Ethernet (VE) driver 208a requests a first address of a mapped, receive data buffer of receiving VE driver 208b, as depicted in block 504. This step is performed by a call by VE driver 208a to hypervisor 210 in response to a data packet transmit request by VE driver 208a. Hypervisor 210 acquires a direct data buffer (DDB) 316 from VE driver 208b.

The way in which hypervisor 210 may acquire DDB 316 upon receiving a call from VE driver 208a can vary. According to one exemplary embodiment, hypervisor 210 can store a cached subset of mapped, receive data buffer addresses before VE driver 208a copies directly to the intended mapped, receive data buffer. Hypervisor 210 can then communicate the cached buffer addresses to virtual Ethernet driver 208a, which copies the data packet directly to the mapped, receive data buffer.

DDB 316 includes the address of a buffer in LPAR 200b to which the data packet is intended to be transmitted. In the case of transferring a data packet from a virtual client to a physical client via SEA 310, DDB 316 points to buffers owned by physical Ethernet driver 312. To enable this, a second mapped address of a transmit data buffer of physical Ethernet driver 312 is mapped to the mapped, receive data buffer of receiving VE driver 208b (block 506). This mapping typically occurs when VIOS 300 and SEA 310 are initially configured at start-up, before internal virtual clients are configured. Next, hypervisor 210 communicates the intended receive data buffer address to VE driver 208a and the receive data buffer address is handed up to stack 206 in kernel space 204a.

Once the receive data buffer location is communicated to VE driver 208a, the process continues to block 508, which illustrates VE driver 208a in kernel space 204a copying the data packet directly from stack 206 to the second mapped address in kernel space 204b. Thus, when VE driver 208b receives from VE driver 208a a data packet that is pre-mapped to the physical transmit data buffer of physical Ethernet driver 312, VE driver 208b will have effectively written into the memory location in physical Ethernet driver 312 that is referenced by DDB 316. Physical Ethernet driver 312a performs a call to SEA 310 to notify receiving VE driver 208b that a data copy to the intended physical transmit data buffer was successful (block 510). The process then terminates thereafter at block 512.

In the flow charts above, one or more of the methods are embodied in a computer readable medium containing computer readable code such that a series of steps are performed when the computer readable code is executed (by a processing unit) on a computing device. In some implementations, certain processes of the methods are combined, performed simultaneously or in a different order, or perhaps omitted, without deviating from the spirit and scope of the invention. Thus, while the method processes are described and illustrated in a particular sequence, use of a specific sequence of processes is not meant to imply any limitations on the invention. Changes may be made with regards to the sequence of processes without departing from the spirit or scope of the present invention. Use of a particular sequence is therefore, not to be taken in a limiting sense, and the scope of the present invention extends to the appended claims and equivalents thereof.

As will be appreciated by one skilled in the art, the present invention may be embodied as a method, system, and/or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module,” “logic”, or “system.” Furthermore, the present invention may take the form of a computer program product on a computer-usable storage medium having computer-usable program code embodied in or on the medium.

As will be further appreciated, the processes in embodiments of the present invention may be implemented using any combination of software, firmware, microcode, or hardware. As a preparatory step to practicing the invention in software, the programming code (whether software or firmware) will typically be stored in one or more machine readable storage mediums such as fixed (hard) drives, diskettes, magnetic disks, optical disks, magnetic tape, semiconductor memories such as RAMs, ROMs, PROMs, etc., thereby making an article of manufacture in accordance with the invention. The article of manufacture containing the programming code is used by either executing the code directly from the storage device, by copying the code from the storage device into another storage device such as a hard disk, RAM, etc., or by transmitting the code for remote execution using transmission type media such as digital and analog communication links. The medium may be electronic, magnetic, optical, electromagnetic, infrared, or semiconductor system (or apparatus or device) or a propagation medium. Further, the medium may be any apparatus that may contain, store, communicate, propagate, or transport the program for use by or in connection with the execution system, apparatus, or device. The methods of the invention may be practiced by combining one or more machine-readable storage devices containing the code according to the described embodiment(s) with appropriate processing hardware to execute the code contained therein. An apparatus for practicing the invention could be one or more processing devices and storage systems containing or having network access (via servers) to program(s) coded in accordance with the invention. In general, the term computer, computer system, or data processing system can be broadly defined to encompass any device having a processor (or processing unit) which executes instructions/code from a memory medium.

Thus, it is important that while an illustrative embodiment of the present invention is described in the context of a fully functional computer (server) system with instilled (or executed) software, those skilled in the art will appreciate that the software aspects of an illustrative embodiment of the present invention are capable of being distributed as a program product in a variety of forms, and that an illustrative embodiment of the present invention applies equally regardless of the particular type of media used to actually carry out the distribution. By way of example, a non exclusive list of types of media, includes recordable type (tangible) media such as floppy disks, thumb drives, hard disk drives, CD ROMs, DVDs, and transmission type media such as digital and analogue communication links.

While the invention has been described with reference to exemplary embodiments, it will be understood by those skilled in the art that various changes may be made and equivalents may be substituted for elements thereof without departing from the scope of the invention. In addition, many modifications may be made to adapt a particular system, device or component thereof to the teachings of the invention without departing from the essential scope thereof. Therefore, it is intended that the invention not be limited to the particular embodiments disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another. As used herein, the singular forms “a”, “an” and “the” are intended to include the plural forms as well, unless the context clearly indicates otherwise. It will be further understood that the terms “comprises” and/or “comprising,” when used in this specification, specify the presence of states features, integers, steps, operations, elements, and/or components, but do not preclude the presence or addition of one or more other features, integers, steps, operations, elements, components, and/or groups thereof.

What is claimed is:

1. A computer-implemented method for circumventing data copy operations in a virtual network environment, said method comprising:
copying a data packet from a user space to a first kernel space of a first logical partition (LPAR);
requesting, via a hypervisor, a mapped address of a receiving virtual Ethernet driver in a second LPAR, wherein said mapped address is associated with a buffer of said receiving virtual Ethernet driver;
copying said data packet directly from said first kernel space of said first LPAR to a destination in a second kernel space of said second LPAR, wherein said destination is determined utilizing said mapped address; and
notifying said receiving virtual Ethernet driver that said data packet has been successfully copied to said destination in said second LPAR.

2. The computer-implemented method of claim 1, further comprising mapping said buffer of said receiving virtual Ethernet driver to a second mapped address of a transmit buffer of a physical Ethernet driver.

3. The computer-implemented method of claim 1, wherein said direct copying to said destination bypasses (i) a data packet copy operation from said first kernel space to a transmitting virtual Ethernet driver of said first LPAR, and (ii) a data packet copy operation via said hypervisor.

4. The computer-implemented method of claim 1, wherein said receiving virtual Ethernet driver includes a Direct Data Buffer (DDB) pool having at least one DDB.

5. The computer-implemented method of claim 4, wherein each of said at least one DDB includes said mapped address pointing to said destination in said second kernel space of said second LPAR.

6. The computer-implemented method of claim 1, further comprising said hypervisor storing a cached subset of mapped buffer addresses before said direct copying.

7. A logically-partitioned data processing system comprising:
a bus;
a memory connected to the bus, wherein a set of instructions are located in memory;
one or more processors connected to the bus, wherein the one or more processors execute a set of instructions to circumvent data copy operations in a virtual network environment, said set of instructions include:
copying a data packet from a user space to a first kernel space of a first logical partition (LPAR);
requesting, via a hypervisor, a mapped address of a receiving virtual Ethernet driver in a second LPAR, wherein said mapped address is associated with a buffer of said receiving virtual Ethernet driver;
copying said data packet directly from said first kernel space of said first LPAR to a destination in a second kernel space of said second LPAR, wherein said destination is determined utilizing said mapped address; and
notifying said receiving virtual Ethernet driver that said data packet has been successfully copied to said destination in said second LPAR.

8. The logically-partitioned data processing system of claim 7, further comprising mapping said buffer of said receiving'virtual Ethernet driver to a second mapped address of a transmit buffer of a physical Ethernet driver.

9. The logically-partitioned data processing system of claim 7, wherein said direct copying to said destination bypasses (i) a data packet copy operation from said first kernel space to a transmitting virtual Ethernet driver of said first LPAR, and (ii) a data packet copy operation via said hypervisor.

10. The logically-partitioned data processing system of claim 7, wherein said receiving virtual Ethernet driver includes a Direct Data Buffer (DDB) pool having at least one DDB.

11. The logically-partitioned data processing system of claim 10, wherein each of said at least one DDB includes said mapped address pointing to said destination in said second kernel space of said second LPAR.

12. The logically-partitioned data processing system of claim 7, further comprising said hypervisor storing a cached subset of mapped buffer addresses before said direct copying.

13. A computer program product comprising:
a computer readable medium; and
program code on said computer readable medium that when executed within a data processing device, said program code provides the functionality of:
copying a data packet from a user space to a first kernel space of a first logical partition (LPAR);
requesting, via a hypervisor, a mapped address of a receiving virtual Ethernet driver in a second LPAR, wherein said mapped address is associated with a buffer of said receiving virtual Ethernet driver;
copying said data packet directly from said first kernel space of said first LPAR to a destination in a second kernel space of said second LPAR, wherein said destination is determined utilizing said mapped address; and
notifying said receiving virtual Ethernet driver that said data packet has been successfully copied to said destination in said second LPAR.

14. The computer program product of claim 13, wherein said program code for mapping said buffer of said receiving virtual Ethernet driver to a second mapped address of a transmit buffer of a physical Ethernet driver.

15. The computer program product of claim 13, wherein said program code for direct copying to said destination bypasses (i) a data packet copy operation from said first kernel space to a transmitting virtual Ethernet driver of said first LPAR, and (ii) a data packet copy operation via said hypervisor.

16. The computer program product of claim 13, wherein said receiving virtual Ethernet driver includes a Direct Data Buffer (DDB) pool having at least one DDB.

17. The computer program product of claim 16, wherein each of said at least one DDB includes said mapped address pointing to said destination in said second kernel space of said second LPAR.

18. The computer program product of claim 13, further comprising said hypervisor storing a cached subset of mapped buffer addresses before said direct copying.
